(19) United States
(12) Patent Application Publication
(10) Pub. No.: US 2025/0230919 A1
(43) Pub. Date: Jul. 17, 2025

(54) LAMP COMPONENT AND LAMP DEVICE

(71) Applicant: SAVANT TECHNOLOGIES LLC, East Cleveland, OH (US)

(72) Inventors: Kun XIAO, Shanghai (CN); Jie GAO, Shanghai (CN); Bin LI, Shanghai (CN)

(73) Assignee: SAVANT TECHNOLOGIES LLC, East Cleveland, OH (US)

(21) Appl. No.: 18/988,129

(22) Filed: Dec. 19, 2024

(30) Foreign Application Priority Data
Dec. 29, 2023 (CN) 2023118612815

(51) Int. Cl. F21V 7/30

(52) U.S. Cl. CPC F21V 7/30

(57) ABSTRACT

Provided is a lamp component and a lamp device. The lamp component includes a reflective layer, having a first face and a second face which is opposite the first face and can be attached to a predetermined position, and a transmissive layer, provided on the first face of the reflective layer, the transmissive layer being doped with fluorescent powder particles, so when first light emitted from an external directional light source is incident on the lamp component from the transmissive layer, a part of the first light interacts with the fluorescent powder particles in the transmissive layer to excite the fluorescent powder particles, to produce second light of a desired color.

### CROSS-REFERENCE TO RELATED APPLICATIONS

This application claims priority to Chinese Patent Application Serial Number 2023118612815, filed Dec. 29, 2023, which is herein incorporated by reference.

### TECHNICAL FIELD

The present disclosure relates to the field of lamps. In particular, the present disclosure relates to a lamp component and a lamp device.

### BACKGROUND

Different lamps have different shapes and constructions, and when the lamps are manufactured, different molds need to be prepared to adapt to different shapes and constructions of lamps; in addition, a lamp comprises multiple components such as a back plate and a diffusion plate, which results in high manufacturing costs of the lamp. In addition, since large-size lamps (e.g. ceiling lamps) have high brightness and low glare, users are increasingly favored for large-size lamps, and an increase in the lamp size inevitably leads to a further increase in manufacturing costs and transportation costs thereof.

In addition, due to the diversity and complexity of the structure of the lamp, when installing the lamp, a professional is required to perform an operation, which also results in a high labor cost for lamp installation.

In view of this, it is desirable to provide a lamp component and a lamp device which can achieve good light brightness and low glare and can reduce manufacturing costs, transportation costs and installation costs of a lamp, to address the described technical problem.

### SUMMARY

An embodiment of the present disclosure provides a lamp component and a lamp device which can achieve good light brightness and low glare in a simple manner and can reduce manufacturing costs, transportation costs and installation costs of a lamp.

According to one embodiment of the present disclosure, provided is a lamp component, that includes a reflective layer, having a first face and a second face which is opposite the first face and can be attached to a predetermined position, and a transmissive layer, provided on the first face of the reflective layer, the transmissive layer being doped with fluorescent powder particles, wherein when first light emitted from an external directional light source is incident on the lamp component from the transmissive layer, a part of the first light interacts with the fluorescent powder particles in the transmissive layer to excite the fluorescent powder particles, to produce second light of a desired color. In this way, a lamp component with a simple structure and low manufacturing costs is provided. Since the lamp unit includes a reflective layer and a transmissive layer which is doped with fluorescent powder particles, good light brightness and low glare can be achieved by irradiating light from the external light source to the transmissive layer.

In the lamp component according to embodiments of the present disclosure, the reflective layer is a silver layer or a multilayer film structure, and the reflectivity of the reflective layer is greater than 80%.

By the described manner, the lamp component has good reflectivity, thereby ensuring the brightness uniformity and low glare of light emitted from the lamp component.

In the lamp component according to embodiments of the present disclosure, the fluorescent powder particles includes at least one of cerium doped yttrium aluminum garnet Ce:YAG, red phosphor of Mn4+ doped potassium fluorosilicate PFS, and YAlO3. In this way, a specific form of the fluorescent powder particles is provided.

In the lamp component according to embodiments of the present disclosure, both the reflective layer and the transmissive layer are flexible.

By the described manner, during transportation, the lamp component can be placed in a bent and folded manner, thereby reducing the space occupied by the lamp component and reducing the transportation costs.

In the lamp component according to embodiments of the present disclosure, the external directional light source is a light source capable of emitting blue light, and the first light is blue light. By the described manner, a specific form of an external directional light source is provided.

In the lamp component according to embodiments of the present disclosure, a part of the first light interacting with the fluorescent powder particles in the transmissive layer to excite the fluorescent powder particles to produce second light of a desired color, comprises at least one of the following: a first part light of the first light incident on the transmissive layer directly interacts with the fluorescent powder particles to excite the fluorescent powder particles, to produce the second light of a desired color; and a second part light of the first light incident on the transmissive layer transmits through the transmissive layer, is incident on the reflective layer, is reflected by the reflective layer and then interacts with the fluorescent powder particles to excite the fluorescent powder particles, to produce the second light of a desired color. By the described manner, a specific manner of the light emitted by the external directional light source interacting with the fluorescent powder particles is provided.

In the lamp component according to embodiments of the present disclosure, the second light is yellow light, green light, red light or white light, and the luminous flux emitted from the lamp component is greater than 100 lumens. In this manner, light emitted from the lamp component can be used for illumination.

In the lamp component according to embodiments of the present disclosure, the lamp component further includes an attachment portion, the attachment portion being provided on the second face of the reflective layer and being used for attaching the lamp component to the predetermined position. By the attachment portion, the lamp component can be flexibly attached to any desired position, and the attachment process is convenient and simple.

According to another embodiment of the present disclosure, provided is a lamp device that includes a lamp component, the lamp component having a reflective layer, having a first face and a second face which is opposite the first face and can be attached to a predetermined position; and a transmissive layer, provided on the first face of the reflective layer, the transmissive layer being doped with fluorescent powder particles; and a directional light source, configured to be able to emit first light to the transmissive layer of the lamp component at a predetermined angle; wherein when first light is incident on the lamp component from the transmissive layer, a part of the first light interacts with the fluorescent powder particles in the transmissive layer to excite the fluorescent powder particles, to produce second light of a desired color. In this way, a lamp device with a simple structure and low manufacturing costs is provided. As the lamp component comprises a reflective layer and a transmissive layer which is doped with fluorescent powder particles, good light brightness and low glare can be achieved by irradiating light from the directional light source to the transmissive layer.

In the lamp device according to another embodiment of the present disclosure, the reflective layer is a silver layer or a multilayer film structure, and the reflectivity of the reflective layer is greater than 80%. By the described manner, the lamp component has good reflectivity, thereby ensuring the brightness uniformity and low glare of light emitted from the lamp component.

In the lamp device according to another embodiment of the present disclosure, the fluorescent powder particles comprise at least one of cerium doped yttrium aluminum garnet Ce:YAG, red phosphor of Mn4+ doped potassium fluorosilicate PFS, or YAlO3. In this way, a specific form of the fluorescent powder particles is provided.

In the lamp device according to another embodiment of the present disclosure, both the reflective layer and the transmissive layer are flexible. By the described manner, during transportation, the lamp component can be placed in a bent and folded manner, thereby reducing the space occupied by the lamp component and reducing the transportation costs.

In the lamp device according to another embodiment of the present disclosure, the directional light source is a light source capable of emitting blue light, and the first light is blue light. By the described manner, a specific form of a directional light source is provided.

In the lamp device according to another embodiment of the present disclosure, a part of the first light interacting with the fluorescent powder particles in the transmissive layer to excite the fluorescent powder particles to produce second light of a desired color, comprises at least one of the following: a first part light of the first light incident on the transmissive layer directly interacts with the fluorescent powder particles to excite the fluorescent powder particles, to produce the second light of a desired color; and a second part light of the first light incident on the transmissive layer transmits through the transmissive layer, is incident on the reflective layer, is reflected by the reflective layer and then interacts with the fluorescent powder particles to excite the fluorescent powder particles, to produce the second light of a desired color. By the described manner, a specific manner of the light emitted by the directional light source interacting with the fluorescent powder particles is provided.

In the lamp device according to another embodiment of the present disclosure, the second light is yellow light, green light, red light or white light, and the luminous flux emitted from the lamp component is greater than 100 lumens. In this manner, light emitted from the lamp component can be used for illumination.

In the lamp device according to another embodiment of the present disclosure, the lamp component further includes an attachment portion, the attachment portion being provided on the second face of the reflective layer and being used for attaching the lamp component to the predetermined position. By the attachment portion, the lamp component can be flexibly attached to any desired position, and the attachment process is convenient and simple.

In the lamp device according to another embodiment of the present disclosure, the lamp device further includes an L-shaped support frame, having a first support rod and a second support rod that is perpendicularly arranged in an L-shape with the first support rod; and a support plate, which is arranged at one end of the first support rod opposite the second support rod and is perpendicular to the first support rod, wherein the lamp component is attached to a face of the support plate facing the second support rod by the attachment portion, and the directional light source is provided at one end of the second support rod opposite the first support rod and can emit the first light to the transmissive layer of the lamp component at the predetermined angle. In this way, a specific arrangement form of the lamp device is provided.

In the lamp device according to another embodiment of the present disclosure, the directional light source is offset from the lamp component by a predetermined distance in a horizontal direction, or directly below the lamp component. In this way, a specific arrangement form of the lamp device is provided.

In the lamp device according to another embodiment of the present disclosure, when installed, the lamp component is attached to a ceiling of a room via the attachment portion, and the directional light source is located on a floor of the room directly below the lamp component or on a side wall of the room. In this way, a specific arrangement form of the lamp device is provided.

According to yet another embodiment of the present disclosure, provided is a lamp device that includes a flexible reflective light-emitting portion and a light source portion away from the flexible reflective light-emitting portion, wherein the reflective light-emitting portion is connected to the light source portion by a connecting portion, the flexible reflective light-emitting portion has a reflective layer and a transmissive layer, and fluorescent excitation substances are provided in the transmissive layer; and when first light emitted from the light source portion is incident on the flexible reflective light-emitting portion, the fluorescent excitation substances are excited by the first light to produce second light, and the first light and the second light are mixed to emit light of a predetermined color outward. In this way, a lamp device with a simple structure and low manufacturing costs is provided. As the flexible reflective light-emitting portion has a reflective layer and a transmissive layer which is doped with fluorescent powder particles, good light brightness and low glare can be achieved by irradiating light from the light source portion to the transmissive layer. During transportation, the flexible reflective light-emitting portion can be placed in a bent and folded manner, thereby reducing the space occupied by the lamp device and reducing the transportation costs.

### BRIEF DESCRIPTION OF THE DRAWINGS

The drawings illustrated herein are used for providing further understanding of the present disclosure and constitute a part of the present disclosure, and the illustrative embodiments of the present disclosure and illustrations thereof are used for explaining the present disclosure, rather than constituting inappropriate limitation on the present disclosure. In the drawings:

FIG. 1 shows a structural diagram of a lamp component according to embodiments of the present disclosure.

FIG. 2 shows a light propagation diagram in a lamp component.

FIG. 3 shows a structural diagram of a lamp device according to embodiments of the present disclosure.

FIG. 4 shows an installation manner of a lamp device according to embodiments of the present disclosure.

FIG. 5 shows a first modification example of a lamp device according to embodiments of the present disclosure.

FIG. 6 shows a second modification example of a lamp device according to embodiments of the present disclosure.

FIG. 7 shows a third modification example of a lamp device according to embodiments of the present disclosure.

### DETAILED DESCRIPTION OF THE EMBODIMENTS

In order to enable a person skilled in the art to understand the solutions of the present disclosure better, hereinafter, the technical solutions in the embodiments of the present disclosure will be described clearly and thoroughly with reference to the accompanying drawings of embodiments of the present disclosure. Obviously, the embodiments as described are only some of embodiments of the present disclosure, and are not all the embodiments. On the basis of the embodiments in the present disclosure, all other embodiments obtained by a person of ordinary skill in the art without any inventive effort shall all fall within the scope of protection of the present disclosure.

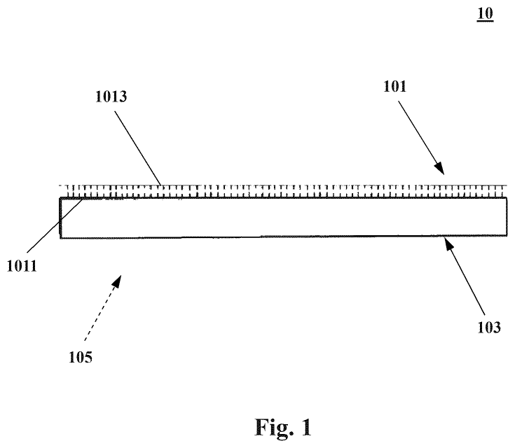

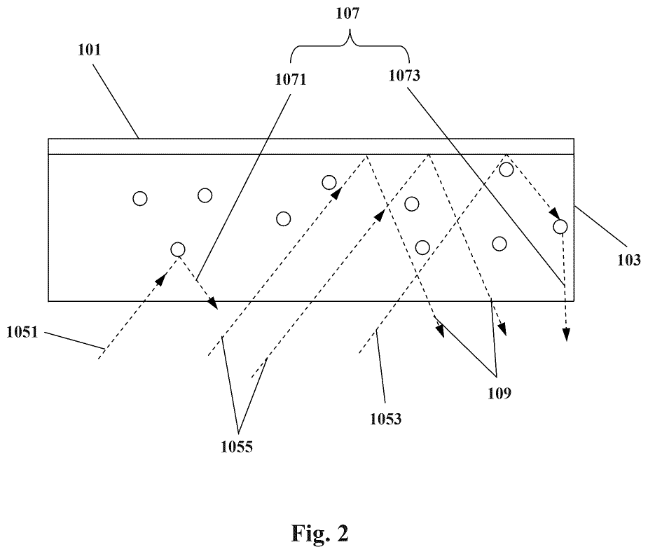

According to embodiments of the present disclosure, a lamp component is provided. FIG. 1 shows a structural diagram of a lamp component according to embodiments of the present disclosure, and FIG. 2 shows a light propagation diagram in the lamp component. Hereinafter, the lamp component according to embodiments of the present disclosure is described in conjunction with FIG. 1 and FIG. 2.

The lamp component 10 can comprise a reflective layer 101 and a transmissive layer 103.

The reflective layer 101 has a first face 1011 and a second face 1013 opposite the first face 1011. The second face 1013 of the reflective layer 101 may be attached to a predetermined position, for example, the wall, ceiling, etc., of a room.

The reflective layer 101 may be a silver layer or a multilayer film structure, and the reflectivity thereof is greater than 80%. For example, the multilayer film structure may be formed by alternate stacking of two or more materials of a titanium dioxide layer, an indium nitride layer, a zinc sulfide layer, tantalum pentoxide, silicon dioxide, silicon nitride, magnesium fluoride and aluminum oxide according to high and low refractive indexes.

The transmissive layer 103 is provided on the first face 1011 of the reflective layer 101, and the transmissive layer 103 is doped with fluorescent powder particles.

The transmissive layer 103 may be a resin layer, such as silica gel, but the present disclosure is not limited thereto.

In the present disclosure, the fluorescent powder particles in the transmissive layer 103 may comprise at least one of: cerium doped yttrium aluminum garnet (Ce:YAG) or other garnet compositions, red phosphor of Mn4+ doped potassium fluorosilicate (PFS), other Mn4+ doped phosphors having a fluoride host, other Eu2+ doped red nitrides and YAlO3 fluorescent powder particles. For example, if a user expects that the fluorescent powder particles generate yellowish light after being excited, then fluorescent powder particles of cerium doped yttrium aluminum garnet (Ce:YAG) or other garnet compositions may be doped into the transmissive layer 103, and the fluorescent powder particles emit yellowish light after being excited; if the user expects that the fluorescent powder particles generate red light after being excited, then red phosphor of Mn4+ doped potassium fluorosilicate (PFS), other Mn4+ doped phosphors having a fluoride host, other Eu2+ doped red nitride phosphor fluorescent powder particles may be doped into the transmissive layer 103; and if the user expects that the fluorescent powder particles generate green light after being excited, YAlO3 fluorescent powder particles may be doped into the transmissive layer 103. By selecting different fluorescent powder particles excited to generate light of different colors, and selecting different solubility ratios of fluorescent powder particles, excited light and incident light have different ratios, and the finally mixed light effects are different. The doping concentration of the fluorescent powder particles may be dependent on the intensity of desired light.

The fluorescent powder particles doped in the transmissive layer 103 are shown above by way of example, but the present disclosure is not limited thereto. The type and concentration of the fluorescent powder particles doped in the transmissive layer 103 may be adjusted according to the color and intensity of light desired by the user.

In the present disclosure, both the reflective layer 101 and the transmissive layer 103 are flexible.

The lamp component 10 according to embodiments of the present disclosure may further comprise an attachment portion (not shown in FIG. 1), the attachment portion being provided on the second face 1013 of the reflective layer 101 and being used for attaching the lamp component 10 to a predetermined position, such as the ceiling, wall, etc. of a room.

The attachment portion may be: an adhesive coated on the second face 1013 of the reflective layer 101, a magnet provided on the second face 1013 of the reflective layer 101, a hook and loop fastener provided on the second face 1013 of the reflective layer 101, etc., but the present disclosure is not limited thereto; and any component capable of attaching the lamp component 10 to a predetermined position can be provided on the second face 1013 of the reflective layer 101 as the attachment portion.

During use, the lamp component 10 can be attached to a predetermined position, such as the ceiling or wall of a room, by means of the attachment portion provided on the second face 1013 of the reflective layer 101.

When first light 105 emitted from an external directional light source is incident on the lamp component 10 from the transmissive layer 103, a part of the first light 105 interacts with the fluorescent powder particles in the transmissive layer 103 to excite the fluorescent powder particles, to produce second light of a desired color.

For example, the external directional light source may be a light source capable of emitting blue light, for example, a blue laser light source, and the first light 105 may be blue light. However, the present disclosure is not limited thereto, and any high-energy light source capable of exciting the fluorescent powder particles may be the external directional light source, for example, the external directional light source may also use ultraviolet light.

The second light may be yellow light, green light, red light or white light, and the color of the second light may be different according to the type of the fluorescent powder particles.

As shown in FIG. 2, a part of the first light 105 interacting with the fluorescent powder particles in the transmissive layer 103 to excite the fluorescent powder particles to produce second light of a desired color may comprise the following situations:
when the first light 105 emitted from the external directional light source is incident on the lamp component 10 from the transmissive layer 103, a first part light 1051 of the first light 105 incident on the transmissive layer 103 directly interacts with the fluorescent powder particles in the transmissive layer 103 to excite the fluorescent powder particles, to produce second light 1071 of a desired color; and/or a second part light 1053 of the first light 105 incident on the transmissive layer 103 transmits through the transmissive layer 103, is incident on the first face 1011 of the reflective layer 101, is reflected by the first face 1011 of the reflective layer 101 and then interacts with the fluorescent powder particles in the transmissive layer 103 to excite the fluorescent powder particles, to produce second light 1073 of a desired color. Hereinafter, when there is no need to distinguish the second light, the second light 1071 and the second light 1073 are collectively referred to as 107.

As shown in FIG. 2, a third part light 1055 in the first light 105 may first transmit through the transmissive layer 103 and is incident on the first face 1011 of the reflective layer 101, is reflected by the first face 1011 of the reflective layer 101 and then transmits through the transmissive layer 103 in the form of third light 109 without exciting any fluorescent powder particles. The second light 107 generated by exciting the fluorescent powder particles by the first part light and the second part light in the first light 105, and the third light 109 directly transmitted out of the transmissive layer 103 are mixed to form light of a predetermined color, e.g. white light, yellow light, colored light, etc.

In the present embodiment, the lamp component only has a two-layer structure of the reflective layer and the transmissive layer, which greatly simplifies the structure of the lamp, reduces the manufacturing cost of the lamp, and can achieve good light brightness and low glare.

In addition, the lamp component can be flexibly installed at any position desired by the user in a simple manner, thereby reducing the installation cost of the lamp.

Since the reflective layer and the transmissive layer of the lamp component are flexible, the lamp component can be placed in a bent and folded manner during transportation, which reduces the space occupied by the lamp component and reduces transportation costs.

Furthermore, compared with components such as a back plate and a diffusion plate required by a traditional lamp, the reflective layer and the transmissive layer of the lamp component are cheap, which further reduces the manufacturing costs of the lamp.

In the present embodiment, the lamp component composed of the flexible reflective layer and transmissive layer can be cut into patterns of different shapes by the user according to different uses, so as to produce different effects of illumination, entertainment, etc. under irradiation from the external directional light source. The luminous flux emitted from the lamp component can be greater than 100 lumens.

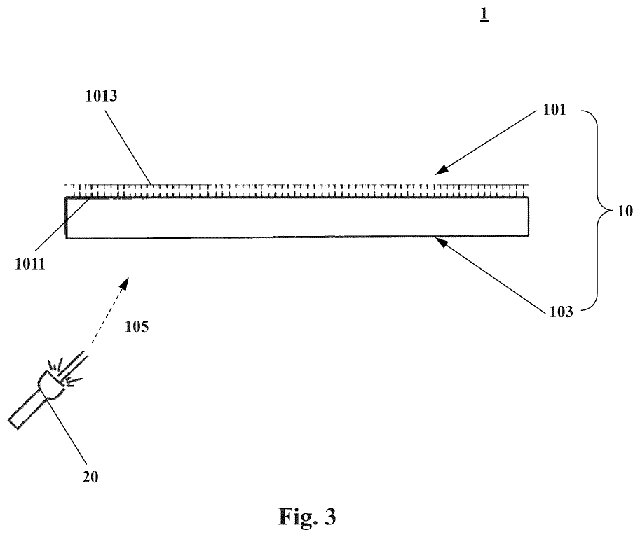

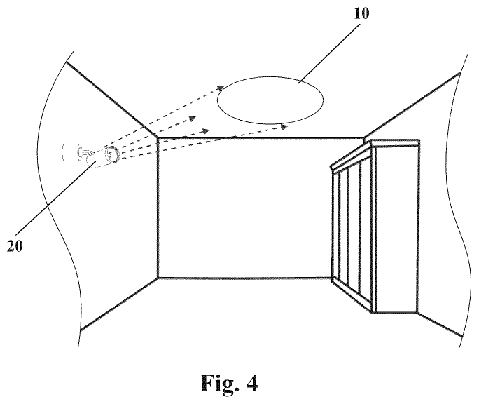

In accordance with another embodiment of the present disclosure, a lamp device is provided. FIG. 3 shows a structural diagram of a lamp device according to embodiments of the present disclosure, and FIG. 4 shows an installation manner of a lamp device according to embodiments of the present disclosure. Hereinafter, the lamp device according to another embodiment of the present disclosure is described in conjunction with FIGS. 3 and 4.

As shown in FIG. 3, the lamp device 1 according to another embodiment of the present disclosure comprises a lamp component 10 and a directional light source 20.

The lamp component 10 comprises: a reflective layer, having a first face and a second face which is opposite the first face and can be attached to a predetermined position; and a transmissive layer, provided on the first face of the reflective layer, the transmissive layer being doped with fluorescent powder particles.

Herein, it should be noted that the specific structure of the lamp component 10 in the lamp device 1 is completely the same as the structure described in conjunction with FIGS. 1 and 2. In order to avoid obscuring the present disclosure due to excessive illustration, the specific structure of the lamp component 10 in the lamp device 1 will not be repeated herein, and the illustration regarding the lamp component 10 in the following illustration can be understood with reference to the illustration above.

The directional light source 20 is configured to be able to emit first light 105 to the transmissive layer 103 of the lamp component 10 at a predetermined angle. When the first light 105 is incident on the lamp component 10 from the transmissive layer 103, a part of the first light 105 interacts with the fluorescent powder particles in the transmissive layer 103 to excite the fluorescent powder particles, to produce second light of a desired color. Here, the predetermined angle may be adjusted appropriately by the user in accordance with the positional relationship between the lamp component 10 and the directional light source 20, as long as light emitted from the directional light source 20 can be incident on a desired part of the lamp component 10.

The directional light source 20 may be a light source capable of emitting blue light, for example, a blue laser light source, and the first light 105 may be blue light. However, the present disclosure is not limited thereto, and any high-energy light source capable of exciting the fluorescent powder particles may be the external directional light source, for example, the directional light source may also use ultraviolet light.

The second light may be yellow light, green light, red light or white light, and the color of the second light may be different according to the type of the fluorescent powder particles.

In conjunction with FIG. 2, a part of the first light 105 emitted from the directional light source 20 interacting with the fluorescent powder particles in the transmissive layer 103 to excite the fluorescent powder particles to produce second light of a desired color may comprise the following situations:
when the first light 105 emitted from the directional light source 20 is incident on the lamp component 10 from the transmissive layer 103, a first part light 1051 of the first light 105 incident on the transmissive layer 103 directly interacts with the fluorescent powder particles in the transmissive layer 103 to excite the fluorescent powder particles, to produce second light 1071 of a desired color; and/or a second part light 1053 of the first light 105 incident on the transmissive layer 103 transmits through the transmissive layer 103, is incident on the first face 1011 of the reflective layer 101, is reflected by the first face 1011 of the reflective layer 101 and then interacts with the fluorescent powder particles in the transmissive layer 103 to excite the fluorescent powder particles, to produce second light 1073 of a desired color.

As shown in FIG. 2, a third part light 1055 in the first light 105 emitted from the directional light source 20 may first transmit through the transmissive layer 103 and is incident on the first face 1011 of the reflective layer 101, is reflected by the first face 1011 of the reflective layer 101 and then transmits through the transmissive layer 103 in the form of third light 109 without exciting any fluorescent powder particles. The second light 107 generated by exciting the fluorescent powder particles by the first part light and the second part light in the first light 105, and the third light 109 directly transmitted out of the transmissive layer 103 are mixed to form light of a predetermined color, e.g. white light, yellow light, colored light, etc.

As shown in FIG. 4, when installed, the lamp component 10 can be attached to the ceiling of a room via an attachment portion, and the directional light source 20 can be located on a side wall of the room where the lamp component 10 is located in the room or on a floor directly below the lamp component.

The content above describes the lamp device in which the lamp component and the directional light source are separately provided according to the embodiments of the present disclosure, but the present disclosure is not limited thereto, and various modifications can be made to the lamp device 1 according to the embodiments of the present disclosure.

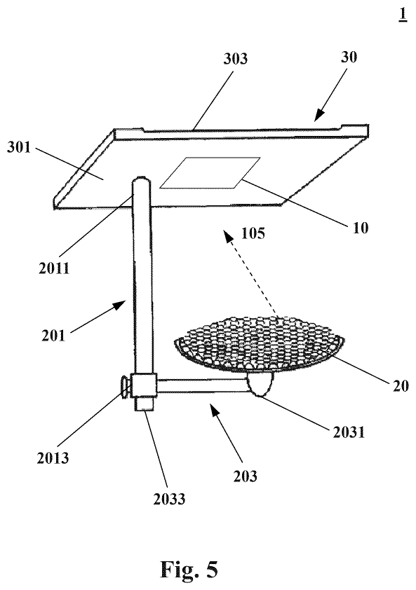

FIGS. 5-7 show first to third modification examples of the lamp device according to embodiments of the present disclosure. Hereinafter, modification examples of the lamp device according to embodiments of the present disclosure are described in conjunction with FIGS. 5-7.

FIG. 5 shows a first modification example of a lamp device according to embodiments of the present disclosure. As shown in FIG. 5, the lamp device 1 according to the first modification example may further comprise an L-shaped support frame and a support plate 30.

The L-shaped support frame has a first support rod 201 and a second support rod 203 that is perpendicularly arranged in an L-shape with the first support rod 201. The first support rod 201 has a first end 2011 and a second end 2013, the second support rod 203 has a first end 2031 and a second end 2033, and the second end 2013 of the first support rod 201 perpendicularly intersects with the second end 2033 of the second support rod 203.

The support plate 30 is provided at the first end 2011 of the first support rod 201, and is perpendicular to the first support rod 201. The support plate 30 has a first face 301 facing the second support rod 203 and a second face 303 opposite the first face 301.

The lamp component 10 is attached to the first face 301 of the support plate 30 by an attachment portion, and the directional light source 20 is provided at the first end 2031 of the second support rod 203 and can emit the first light 105 to the transmissive layer of the lamp component 10 at a predetermined angle.

The directional light source 20 may be offset from the lamp component 10 by a predetermined distance in a horizontal direction, or directly below the lamp component 10.

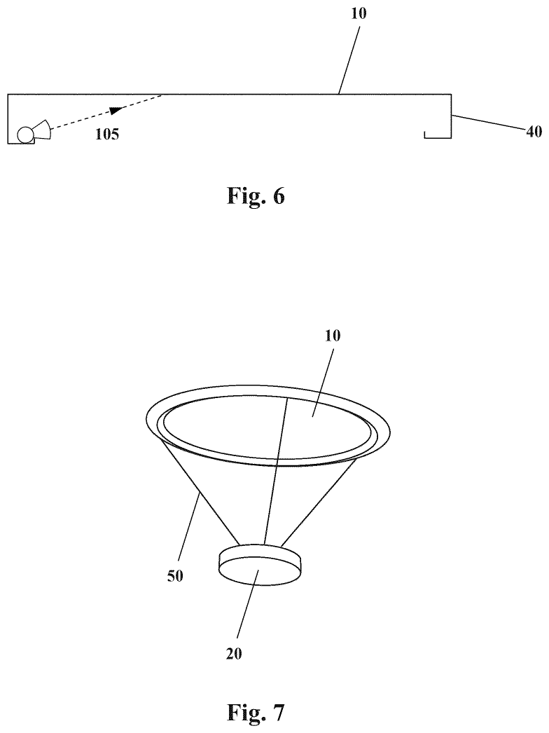

FIG. 6 shows a second modification example of a lamp device according to embodiments of the present disclosure. As shown in FIG. 6, the lamp device 1 according to the second modification example may further comprise a connecting portion 40, for connecting the lamp component 10 and the directional light source 20.

The connecting portion 40 is arranged around the outer edge of the lamp component 10, a first end of the connecting portion 40 is connected to the outer edge of the lamp component 10, and a second end of the connecting portion 40 extends perpendicularly to the plane where the lamp component 10 is located to below the plane. The second end of the connecting portion 40 is connected to and supports the directional light source 20.

A groove for accommodating the directional light source 20 is provided at the second end of the connecting portion 40. There may be a plurality of directional light sources 20, and when installed, the lamp component 10 may be attached to the ceiling of a room, and the plurality of directional light sources 20 may be provided in the groove of the second end of the connecting portion 40 around the outer edge of the lamp component 10 at a predetermined interval.

The directional light sources 20 may emit the first light 105 to the lamp component 10 at a predetermined angle, thereby exciting the fluorescent powder particles in the lamp component 10 to produce light of a desired color.

FIG. 7 shows a third modification example of a lamp device according to embodiments of the present disclosure. As shown in FIG. 7, the lamp device 1 according to the third modification example can further comprise a plurality of connecting wires 50 for connecting the lamp component 10 and the directional light source 20; the lamp component 10 may be of flexible round, oval or annular shapes, and can be bent, thereby facilitating transportation and installation. Three connecting wires 50 are shown in FIG. 7, but the present disclosure is not limited thereto, and more or less connecting wires may be provided as needed.

In FIG. 7, the three connecting wires 50 have the same length, and first ends of the three connecting wires 50 are connected to the lamp component 10 at uniform intervals along the outer edge of the lamp component 10, and second ends of the three connecting wires 50 are connected to the directional light source at uniform intervals along the outer edge of the directional light source 20, so that the directional light source 20 is located directly below the lamp component 10 when the lamp device is hung at a predetermined position.

The directional light source 20 located directly below the lamp component 10 may emit the first light to the lamp component 10 at a predetermined angle, thereby exciting the fluorescent powder particles in the lamp component 10 to produce light of a desired color.

The connecting wires in FIG. 7 may be flexible wires, but the present disclosure is not limited thereto.

On the basis of the described modification examples of the lamp device, the lamp device according to embodiments of the present disclosure may also be summarized as follows.

A lamp device, comprising a flexible reflective light-emitting portion and a light source portion away from the flexible reflective light-emitting portion, wherein the reflective light-emitting portion is connected to the light source portion by a connecting portion, the flexible reflective light-emitting portion has a reflective layer and a transmissive layer, and fluorescent excitation substances are provided in the transmissive layer; and when first light emitted from the light source portion is incident on the flexible reflective light-emitting portion, the fluorescent excitation substances are excited by the first light to produce second light, and the first light and the second light are mixed to emit light of a predetermined color outward.

Although the lamp component is shown in circular and rectangular shapes in the drawings, the present disclosure is not limited thereto; and the lamp component may have various shapes according to user requirements.

According to the lamp device of the embodiments of the present disclosure, a lamp device with a simple structure and low manufacturing costs is provided. As the flexible reflective light-emitting portion has a reflective layer and a transmissive layer which is doped with fluorescent powder particles, good light brightness and low glare can be achieved by irradiating light from the light source portion to the transmissive layer. During transportation, the flexible reflective light-emitting portion can be placed in a bent and folded manner, thereby reducing the space occupied by the lamp device and reducing the transportation costs.

In the embodiments of the present disclosure, the illustration of each embodiment has its own emphasis. For the part not detailed in a certain embodiment, please refer to the relevant illustration in other embodiments.

The content above only relates to preferred embodiments of the present disclosure. It should be noted that for a person of ordinary skill in the art, several improvements and modifications can also be made without departing from the principle of the present disclosure. and these improvements and modifications shall also be considered as within the scope of protection of the present disclosure.

1. A lamp component, comprising:
a reflective layer, having a first face and a second face which is opposite the first face and can be attached to a predetermined position; and
a transmissive layer, provided on the first face of the reflective layer, and the transmissive layer being doped with fluorescent powder particles,
wherein when first light emitted from an external directional light source is incident on the lamp component from the transmissive layer, a part of the first light interacts with the fluorescent powder particles in the transmissive layer to excite the fluorescent powder particles, to produce second light of a desired color.

2. The lamp component according to claim 1, wherein
the reflective layer is a silver layer or a multilayer film structure, and the reflectivity of the reflective layer is greater than 80%.

3. The lamp component according to claim 2, wherein
the fluorescent powder particles comprise at least one of cerium doped yttrium aluminum garnet Ce:YAG, red phosphor of Mn⁴⁺ doped potassium fluorosilicate PFS, or YAlO₃.

4. The lamp component according to claim 1, wherein
both the reflective layer and the transmissive layer are flexible.

5. The lamp component according to claim 1, wherein
the external directional light source is a light source capable of emitting blue light, and the first light is blue light.

6. The lamp component according to claim 1, wherein
a part of the first light interacting with the fluorescent powder particles in the transmissive layer to excite the fluorescent powder particles to produce second light of a desired color, comprises at least one of the following:
a first part light of the first light incident on the transmissive layer directly interacts with the fluorescent powder particles to excite the fluorescent powder particles, to produce the second light of a desired color; and
a second part light of the first light incident on the transmissive layer transmits through the transmissive layer, is incident on the reflective layer, is reflected by the reflective layer and then interacts with the fluorescent powder particles to excite the fluorescent powder particles, to produce the second light of a desired color.

7. The lamp component according to claim 1, wherein
the second light is yellow light, green light, red light or white light, and the luminous flux emitted from the lamp component is greater than 100 lumens.

8. The lamp component according to claim 1, wherein
the lamp component further comprises an attachment portion, the attachment portion being provided on the second face of the reflective layer and being used for attaching the lamp component to the predetermined position.

9. A lamp device, comprising:
a lamp component, the lamp component comprising:
a reflective layer, having a first face and a second face which is opposite the first face and can be attached to a predetermined position; and
a transmissive layer, provided on the first face of the reflective layer, and the transmissive layer being doped with fluorescent powder particles; and
a directional light source, configured to be able to emit first light to the transmissive layer of the lamp component at a predetermined angle;
wherein when first light is incident on the lamp component from the transmissive layer, a part of the first light interacts with the fluorescent powder particles in the transmissive layer to excite the fluorescent powder particles, to produce second light of a desired color.

10. The lamp device according to claim 9, wherein
the reflective layer is a silver layer or a multilayer film structure, and the reflectivity of the reflective layer is greater than 80%.

11. The lamp device according to claim 10, wherein
the fluorescent powder particles comprise at least one of cerium doped yttrium aluminum garnet Ce:YAG, red phosphor of Mn⁴⁺ doped potassium fluorosilicate PFS, or YAlO₃.

12. The lamp device according to claim 9, wherein
both the reflective layer and the transmissive layer are flexible.

13. The lamp device according to claim 9, wherein
the directional light source is a light source capable of emitting blue light, and the first light is blue light.

14. The lamp device according to claim 9, wherein
a part of the first light interacting with the fluorescent powder particles in the transmissive layer to excite the fluorescent powder particles to produce second light of a desired color, comprises at least one of the following:
a first part light of the first light incident on the transmissive layer directly interacts with the fluorescent powder particles to excite the fluorescent powder particles, to produce the second light of a desired color; and
a second part light of the first light incident on the transmissive layer transmits through the transmissive layer, is incident on the reflective layer, is reflected by the reflective layer and then interacts with the fluorescent powder particles to excite the fluorescent powder particles, to produce the second light of a desired color.

15. The lamp device according to claim 9, wherein
the second light is yellow light, green light, red light or white light, and the luminous flux emitted from the lamp component is greater than 100 lumens.

16. The lamp device according to claim 9, wherein
the lamp component further comprises an attachment portion, the attachment portion being provided on the second face of the reflective layer and being used for attaching the lamp component to the predetermined position.

17. The lamp device according to claim 16, wherein the lamp device further comprises:
an L-shaped support frame, having a first support rod and a second support rod that is perpendicularly arranged in an L-shape with the first support rod; and
a support plate, which is arranged at one end of the first support rod opposite the second support rod and is perpendicular to the first support rod,
wherein the lamp component is attached to a face of the support plate facing the second support rod by the attachment portion, and the directional light source is provided at one end of the second support rod opposite the first support rod and can emit the first light to the transmissive layer of the lamp component at the predetermined angle.

18. The lamp device according to claim 17, wherein
the directional light source is offset from the lamp component by a predetermined distance in a horizontal direction, or directly below the lamp component.

19. The lamp device according to claim 16, wherein
when installed, the lamp component is attached to a ceiling of a room via the attachment portion, and the directional light source is located on a floor of the room directly below the lamp component or on a side wall of the room.

20. A lamp device, comprising:
a flexible reflective light-emitting portion and
a light source portion away from the flexible reflective light-emitting portion,
wherein the reflective light-emitting portion is connected to the light source portion by a connecting portion, the flexible reflective light-emitting portion has a reflective layer and a transmissive layer, and fluorescent excitation substances are provided in the transmissive layer; and
when first light emitted from the light source portion is incident on the flexible reflective light-emitting portion, the fluorescent excitation substances are excited by the first light to produce second light, and the first light and the second light are mixed to emit light of a predetermined color outward.
